(19) United States
(12) Patent Application Publication
(10) Pub. No.: US 2006/0108221 A1
(43) Pub. Date: May 25, 2006

(54) Method and apparatus for improving measuring accuracy in gas monitoring systems

(76) Inventors: William Goodwin, Medway, MA (US); Mark Phelps, Attleboro, MA (US); Jurgen Michael Lobert, Franklin, MA (US); Bruce Laquidara, Oakland, MA (US); Anatoly Grayfer, Newton, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/997,043

(22) Filed: Nov. 24, 2004

(51) Int. Cl. G01N 27/26

(52) U.S. Cl. 204/424

(57) ABSTRACT

A method and apparatus for improving measurement accuracy in a gas monitoring system is provided. The apparatus can be connected to a plurality of gas sample lines each containing a gas sample. The gas samples are routed through a number of delivery channels which are fewer in number than the plurality of sample lines. Each delivery channel is alternatively coupled to a detector which identifies contaminants present in the gas samples. Each delivery channel includes a voltage sensitive orifice (VSO). The VSO's are operated by a controller and provide gas samples at a constant flow and a constant pressure to the detector independent of the length of the gas sample line being measured.

### BACKGROUND OF THE INVENTION

In semiconductor manufacturing processes even low concentrations of airborne molecular contaminates can reduce device yields and increase the incidence of defects. For example, concentrations of gas-phase amines, such as ammonia (NH₃) and n-methyl-2-pyrrolidinone (NMP), at part-per-billion (ppb) levels can react with photoresists and lead to “T-topping.” These semiconductor manufacturing processes are sensitive to NMP, ammonia, or other amines, as well as being sensitive to the total proton-bonding capability of all nitrogen-containing base contaminants present, regardless of the specific identity of the amine contamination. As a result, the filtration and measurement of ammonia only is not satisfactory to photolithographic processes that are affected by low concentrations of basic nitrogen-containing species, such as photolithography using chemically amplified DUV, because ammonia is typically not the only basic nitrogen-containing airborne contaminant present. In addition, measurement of only the total fixed nitrogen species present is also not sufficient because many typical contaminant species (for example, HCN, NO, NO₂) are not basic in nature and do not significantly affect the photolithography process.

To avoid harm to the semiconductor manufacturing process from NMP or ammonia, semiconductor manufacturers have used systems of chemical filters to remove these contaminants. As air flows through the filtering system, unwanted contaminants are retained on the surface of the various filters. A problem associated with such filtering systems has been to accurately predict the remaining life of filtering media used in the system so that filters can be changed at appropriate times with minimal disruption to the use of the expensive production facility. One approach to filter replacement has been to replace filters after they begin to fail, e.g., by observing the slope of sidewalls in test lines until a certain degree of negative sloping (T-topping) is observed. One problem of this approach is that it replaces filters after a “failure” has already occurred with the concomitant loss in yield and increase in defects.

Another approach is to replace filters based on their age and/or the volume of air filtered, similar in concept to replacing automotive oil filters based on mileage. A problem associated with this approach is that filters may be replaced prematurely, incurring unnecessary filter replacement costs and unnecessary downtime of the facility. Another problem of this approach is that the estimated filter lifetimes may be too long, resulting in filter failure before replacement and process contamination.

A third approach is to monitor the concentration of airborne contaminants and replace filters before the contaminant concentration reaches levels that may be harmful to the semiconductor manufacturing process. However, harmful contamination concentrations can be very low, for example, in the ppb range for NMP and ammonia in deep ultraviolet (DUV) photolithography; and reliably monitoring such low concentrations has traditionally been problematic.

The measurement of ppb level or less concentrations presents still further problems. For example, fluctuations in the conductance (C) of a gas sample flow path can add significant error to a concentration measurement, which can be compounded if the concentration of a species of interest is determined from differencing or adding two or more concentration measurements. Measurement errors such as these can lead to interferences that create spurious signals and act as noise contributions to data being measured.

Changes in flow path conductance can become more problematic as the length of a flow path increases. Typically, the longest portion of a flow path for a gas sample is the gas sampling line connecting a sampling site (for example, a semiconductor processing tool or system, a part of the air filtration system, a stepper or track stage of a photolithographic tool cluster, a clean room, etc.) to the detector of the gas monitor. In addition, where the concentration of a species of interest is determined from differencing or adding two or more concentration measurements, and such measurements use different flow paths (for example, within the gas monitor); differences in the conductance between the flow paths can add additional error to the concentration value of the species of interest.

### SUMMARY OF THE INVENTION

The present invention provides systems and methods for monitoring contaminants such as gas-phase basic nitrogen-containing species in gas streams for example, from one or more sampling sites that facilitate the monitoring of such species at low concentration. In preferred embodiments, the systems and methods of the present invention monitor a plurality of sampling sites using a substantially constant gas pressure. A variable orifice valve system is used to control fluid flow from the sampling location to maintain a constant pressure in the flow path to the detector system. In a preferred embodiment a selected channel controls the flow rate and one or more unselected channels are used to control pressure. This provides a more accurate and repeatable measurement of the trace contaminants frequently formed in ambient gases used in semiconductor fabrication equipment.

In various embodiments, the systems and methods of the present invention provide a gas monitor that facilitates determining gas filter performance and, preferably, one or more indicators of remaining gas filter service life, a prediction of next filter change, and a notification of potential filter failure. The gas monitor can further provide, for example, a warning indicator including, but not limited to, colored lights (for example, constant or flashing, red, yellow and green lights to indicate differing levels of contaminant concentrations); pages (for example, to page an operator regarding the contaminant concentration); and audio alarms. The gas monitor can provide a display that can include qualitative and/or quantitative information including, but not limited to, remaining gas filter service life, next filter change, filter status, and semiconductor tool and/or system status. For example, in various embodiments, the gas monitor can display information that includes, but is not limited to, the predicted absolute remaining gas filter service life, the time since last filter change, the predicted time to next filter change, filter type, filter location, the failure history of a filter, the replacement history of a filter, an indicator of predicted imminent filter failure, and an indicator of actual filter failure.

In one aspect, the present invention provides a gas monitor. In various embodiments, a gas monitor according to the invention comprises three or more delivery channels through which gas samples from a sampling site pass; one or more converters connectable to the delivery channels that convert nitrogen-containing gas-phase compounds into NO; at least one amine remover or scrubber positioned in one of the delivery channels upstream of a converter to remove basic gas-phase nitrogen compounds from a gas sample; at least one detector that provides signals representative of the NO concentration in a gas sample; and at least one variable orifice in the flow path to the detector that regulates the flow of a gas sample through a delivery channel to the detector.

In various embodiments, the present invention provides a gas monitor having: an inlet gas channel for providing a gas sample; a first delivery channel connected to the inlet gas channel, the first delivery channel having a first variable orifice positioned to regulate gas flow through the first delivery channel; valving for alternatively connecting the first delivery channel to a detector that selectably receives a gas sample for measurement. In various embodiments, the present invention provides a gas monitor that further includes a second delivery channel connected to the inlet gas channel, the second delivery channel having a second variable orifice positioned to regulate gas flow through the second delivery channel; valving for alternatively connecting the second channel to the detector.

Preferably, the gas monitor includes an orifice controller to control the size of the first, second or third variable orifices for regulating gas flow rate when a gas sample is directed to the detector through any one of the measurement channels by the respective delivery channels. In addition, a third delivery channel connected to the inlet gas channel is provided. The third delivery channel can have a third variable orifice positioned to regulate gas flow through the third delivery channel valving for alternatively connecting the third delivery channel to the detector. The detector system can include a reaction chamber coupled to a photomultiplier tube, for example that is cooled by a temperature controller.

In various embodiments, a gas monitor according to the present invention includes three delivery channels: a first channel comprising a converter capable of converting gas-phase nitrogen-containing species in a gas sample to an indicator gas; a second channel comprising an amine remover, positioned upstream of a converter, the amine remover capable of removing one or more basic gas-phase nitrogen-containing species from a gas sample; and a third channel. The first and second channels can use the same converter, separate converters, or both a shared converter and separate converters. For example, in one embodiment, the first channel includes a first converter separate from the second channel which includes a second converter. In another embodiment, the first and second channels alternatively access the same converter, for example, using valving to selectively connect a channel to the converter. The third channel can be used to provide a gas sample to the detector for determination, for example, of the background level of indicator gas in gas samples from a sampling site.

In various embodiments, the target flow rate is in the range from about 0.1 lpm to about 2.0 lpm and the target pressure is in the range from about 20 Torr to about 750 Torr. In preferred embodiments, the target flow rate is in the range from about 0.4 lpm to about 0.7 lpm and the target pressure is in the range from about 70 Torr to about 120 Torr mmHg.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates an exemplary flow chart for monitoring contaminants in a gas sample in accordance with embodiments of the invention;

FIG. 2 illustrates a schematic representation of an embodiment operating in conjunction with semiconductor fabrication tools;

FIG. 3 illustrates a schematic representation of an exemplary embodiment of a gas sampling subsystem in accordance with an embodiment of the invention;

FIG. 4 illustrates a view of a controller in accordance with a preferred embodiment of the invention;

FIG. 5 illustrates a schematic representation of a control system for use when practicing exemplary embodiments of the invention; and

FIG. 6 illustrates an exemplary system including a back panel configuration for use with exemplary embodiments of the invention;

FIG. 7 illustrates a flow chart showing an exemplary method for operating exemplary embodiments of a gas sampling subsystem.

FIGS. 8A, 8B and 8C graphically illustrate flow stabilization, and pressure and flow characteristics of the present invention relates to existing systems.

### DETAILED DESCRIPTION OF EMBODIMENTS

Embodiments disclosed herein regulate the flow rate of a gas sample to a detector by controlling the size of one or more variable orifices in the flow path of the gas sample to the detector. In an embodiment, a gas sampling subsystem employs one or more variable orifices in the flow path to regulate gas flow such that during detector measurements, the gas flow rate varies by less than about 0.5% from a target flow rate. In preferred embodiments, these variable orifices can comprise voltage sensitive orifices (VSO's). At substantially the same time, one or more VSO's outside the flow path of a gas sample flowing to the detector regulate the pressure of the gas sample being measured in the detector such that during detector measurements the pressure of the gas sample in the detector varies by less than about 0.5% from a target pressure. In this embodiment, substantially constant flow and pressure can be maintained independent of the length of the gas sample line being measured.

As such, the gas sampling subsystem can be used in a monitor that facilitates determining the performance of a gas filtering system. For example, the subsystem may be used for obtaining gas samples from sampling sites located downstream of a filter system, from sampling sites disposed between stages of a filter system, and from sampling sites located upstream of a filtering system. These samples are then used to monitor filter system performance. Sampling sites located upstream of the filter system can be used to monitor the chemical contamination to which the filtering system is being exposed, and sampling sites located downstream of the filtering system can be used to monitor overall filter system performance and to detect actual or imminent failure of the filtering system (for example, breakthrough). Sampling sites located between stages of the filtering system can be used to provide information to assist in indicating when change of the filter elements should be scheduled. In addition, an intermediate port closest to the outlet can be employed to verify the fidelity of the outlet air as a zero reference for the detection system.

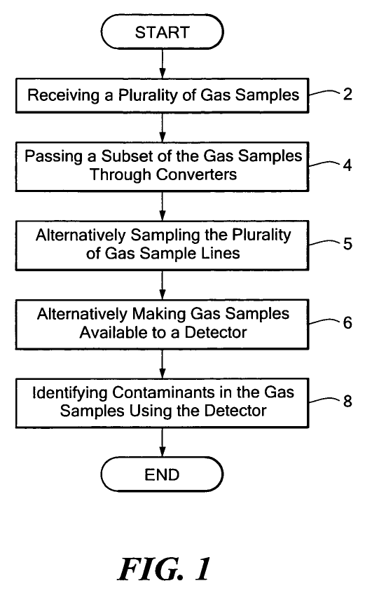

FIG. 1 illustrates an exemplary method for analyzing gas samples containing contaminants. A VSO subsystem receives substantially any number of gas samples by way of a plurality of gas sample lines (per step 2). These incoming gas sample lines may be directly coupled to the subsystem via direct connections, or gas samples can be multiplexed before reaching the subsystem such that a connection to the subsystem may be capable of making gas samples from a plurality of gas sample lines available to the subsystem. Once at the subsystem, some subset of the gas sample lines may be passed through one, or more, converters or other gas conversion devices known in the art (per step 4). The subsystem alternatively samples the plurality of gas sample lines (per step 5) such that a single sample is available to a detector during a measurement (per step 6). The detector then identifies contaminants present in an analyzed gas sample using techniques known in the art (per step 8).

As shown in FIG. 1, the VSO subsystem facilitates the analysis of contaminants received from essentially any number of sources having differing lengths using a single device.

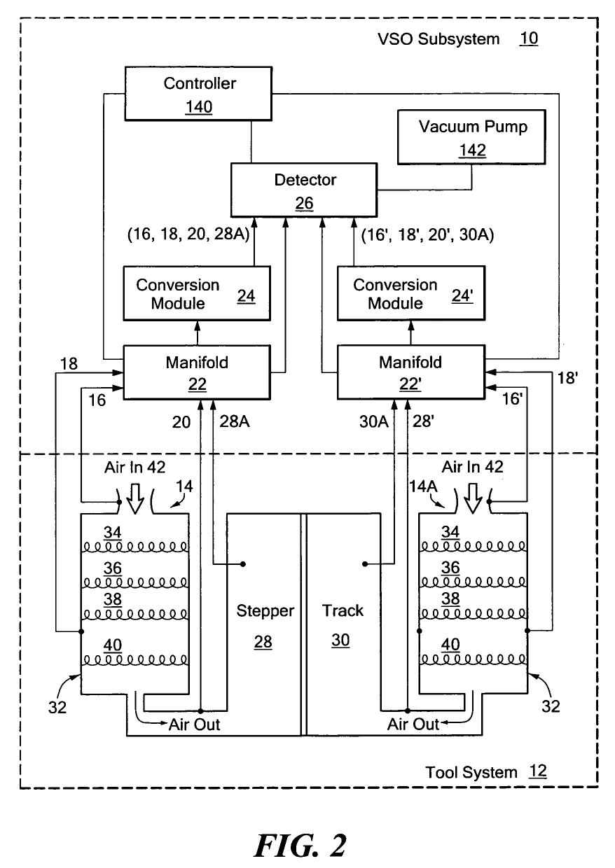

FIG. 2 illustrates a schematic diagram showing a VSO subsystem 10 being used to monitor contaminants contained in gas sample lines associated with a semiconductor fabrication facility. The embodiment illustrated in FIG. 2 receives a total of 8 input gas sample lines; however, essentially any number of gas sample lines may be employed.

A photolithography tool cluster is shown as tool system 12 in FIG. 2. Photolithography tool clusters such as tool system 12 are used in the production of semiconductor wafers. The tool cluster consists of two tools, a stepper 28 and a track 30. A wafer processed by the cluster is coated with photoresist in track 30, then transferred to the stepper 28 where the coated wafer is exposed to ultraviolet radiation passing through a reticle, and then transferred back to the track 30 where the exposed photoresist is developed. Each of these tools 28, 30 is joined to a separate clean air filtration system, 14 and 14a, respectively. The clean air filtration systems each consist of a filtration tower having a metal enclosure 32 and a set of spaced apart chemically-active filter stages 34, 36, 38, 40 installed in series within the enclosure. As depicted in FIG. 2, the air enters at 42, at the top of the tower. The air is supplied from outside the fabrication facility, from within the facility, or from within the clean room or the tool itself. This system and its operation are more fully described in U.S. Pat. Nos. 6,096,267, 6,207,460, 6,296,806, 6,740,147, 6,759,254 and U.S. application Ser. No. 10/933,692, filed Sep. 2, 2004, the teachings of these patents and applications being hereby incorporated by reference in their entirety.

Filters are composed of chemically-active composite materials, typically nonwoven fabric media, to which are bound activated carbon particles or ion exchange beads that have been treated to remove ammonia and organic amines. The filter media is typically arranged as a set of pleats in the enclosure. An example of such filter media is known by the trademark, Vaporsorb™, produced by the Assignee, Extraction Systems Inc. of Franklin, Mass. U.S.A.

In the embodiment of FIG. 2, a manifold-converter-detector subsystem, the VSO subsystem 10, is employed to monitor performance of a filter deployed in either the make-up or recirculation air supplying a clean room. In this case, the VSO subsystem 10 is employed in such a manner as to monitor total basic nitrogen compounds both upstream and downstream of a filter deployed either alone or in series in the make-up or recirculation air system of the clean room.

In other implementations, different filter media are employed. A preferred embodiment utilizes combinations of filter media as described in U.S. Pat. No. 6,740,147 incorporated herein by reference. Certain examples include parallel trays of loose activated carbon particles produced by, e.g., Donaldson Company (Minneapolis, Minn. USA); extruded carbon blocks using a dry thermoplastic adhesive as the binding agent as produced by, e.g., Flanders Filters (Washington, N.C. USA), KX Industries, and Peneer Industries; thin extruded carbon blocks manifest as a fabric as manufacturing by, e.g., KX Industries; media made by the modification of the chemical properties of the fiber structure as produced by, e.g., Ebara Corp. (Tokyo, Japan) and Takuma Ltd.; and carbon fiber structures as produced by, e.g., Kondoh Ltd.; and carbon particle sheet media produced by, e.g., Hoechst-Celanese.

As shown in FIG. 2, each filtration tower, 14 and 14a, includes, respectively, an upstream sampling port 16, 16′, a downstream sampling port 20, 20′, and an intermediate sampling port, 18, 18′. Sampling ports 28a and 30a are likewise provided for the stepper 28 and track 30, respectively. For each filter and tool combination, there is one conversion module 24 (for the stepper 28) and 24′ (for the track 30). The conversion modules 24 and 24′ are connected to a common, remotely-located NO detector 26.

In other embodiments, a single conversion module receives gas samples from both tools 28 and 30 and delivers the converted samples to the detector 26. In this case, the conversion module and the detector 26 can be in the form of a Model 17 instrument, which is available from Thermo Environmental Instruments Inc. (Franklin, Mass., USA). Although the remaining description relating to FIG. 2 is generally directed to the illustrated embodiment, which includes a pair of conversion modules 24 and 24′, a single conversion module or more than three conversion modules can generally be used.

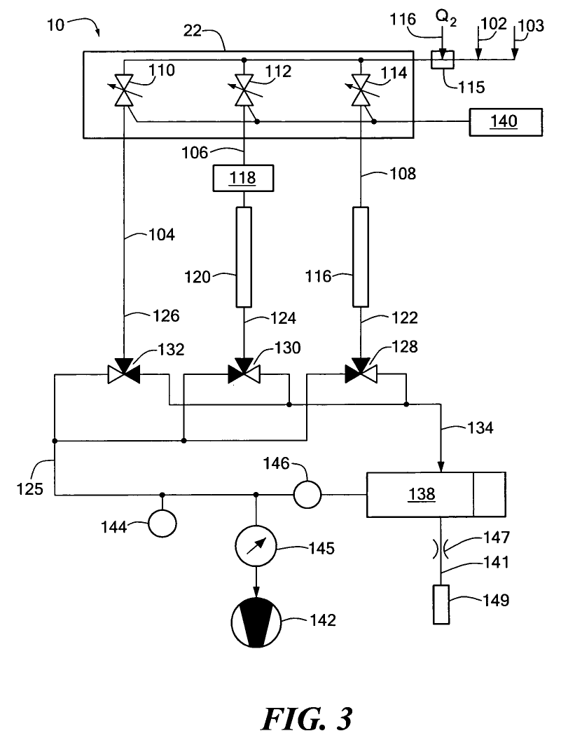

FIG. 3 illustrates an exemplary VSO subsystem 10 for sampling a gas flow to detect contaminants associated therewith. Subsystem 10 includes a sample input line 102, 103 is coupled to manifold 22. For a given measurement, one of the sample lines 102, 103 will be selected and distributed across a plurality of delivery channels. In the embodiment of FIG. 3, for example, sample input line 102 is divided into three delivery channels, first delivery channel 104, second delivery channel 106 and third delivery channel 108, respectively. The delivery channels 104, 106, 108 convey the gas sample past voltage sensitive orifices (VSO's) 110, 112 and 114, respectively. The delivery channels 104, 106, 108 may deliver NO, NOₓ and NO_{T} respectively for example and can comprise stainless steel or glass tubing coated with silica. The silica may be deposited on the channel tubing using chemical vapor deposition. The channel tubing is heatable substantially along its total length to reduce amine deposition on the walls of the tubing.

The VSO's 110, 112, 114 may reside in manifold 22 or may be operated as separate modules and are controlled by controller 140 by way of electrical signals. In a preferred embodiment, the VSO's 110, 112, 114 are controlled using pulse-width modulated signals. A control signal causes the size of an internal orifice, located within a VSO, to increase or decrease in size causing a corresponding increase or decrease, respectively, in the gas volume flowing through that VSO. The VSO's 110, 112, 114 may be controlled individually or collectively as desired.

The channels 104, 106 and 108 can include of gas conversion, gas scrubbing or gas feed devices. A gas conversion device receives a gas sample containing contaminants and converts at least a portion of the contaminants into another form or substance and further passes the converted sample to its output for use by downstream devices and systems. Systems and methods for converting contaminants are described in detail in the previously referenced patents and application incorporated herein by reference. In contrast, a gas scrubber device receives a gas sample containing contaminants and removes at least a substantial portion of a contaminant from the sample before making it available to downstream devices and systems. A feed device receives a gas sample and passes it along to downstream devices and systems in substantially the same form it was received. An example of a feed device is a piece of gas impermeable tubing. Note that a separate valve 115 can be used to control delivery of an oxidant such as air or oxygen into the inlet of the delivery channel system. This is useful particularly with the use of nitrogen in the optical system of a photolithography operating at 157 mm wavelength, for example.

VSO subsystem 10 can provide the total concentration of basic nitrogen-containing gas-phase species in the air from a sampling site which can be determined from the difference between a detected indicator gas concentrations in: (1) a gas sample from a sampling site that has been passed through a converter 116 which converts gas-phase nitrogen-containing species into an indicator gas; and (2) a gas sample from the sampling site that has not been passed through a converter; and (3) a gas sample from the sampling site that has been passed through an amine remover 118 which removes one or more species basic gas-phase nitrogen-containing species from a gas sample and then through a converter 120 which converts gas-phase nitrogen-containing species into the indicator gas.

The output 116 is coupled to line 122. Line 122, in turn, is alternately connected to the input line 130 chamber 138 or terminated. When line 122 is coupled to chamber input 134 using switch 128, the gas sample present therein is drawn into chamber 138 by way of vacuum pump 142. The sample is then analyzed in chamber 138 using techniques known in the art such as chemiluminescence detection. Valves 130 and 132 control sampling from lines 124 and 126 respectively. When line 122 is coupled to detector chamber 138, lines 124 and 126 run to output 125. As such, embodiments of the invention operate with only a single channel feeding detector 138 at a given time. When line 122 is sampled by detector 138 gas flow occurs through line 122 at a constant flow rate. Use of a constant flow rate into detector 138 across any sampled channel makes possible channel-to-channel comparisons with respect to concentrations of contaminants within each sampled channel. Subsystem 10 employs a constant volume through detector 138 from one channel to the next which allows differential measurements to be produced in that subsystem 10 facilitates determining the number of molecules per unit volume. In a preferred embodiment, a flow rate of one-half liter per minute (½ L/min) is used on the channel being sampled while a pressure of 80 mm of mercury is maintained on each of the unsampled, or bypassed, channels for example. A flow meter 146 and pressure sensor 144 are used in conjunction with detector 138 and controller 140 to maintain a consistent volume within detector 138 from measurement to measurement. Flow meter 146 and pressure sensor 144 are equipped with analog-to-digital converters (ADC's) for converting analog sensor signals to digital signals used by controller 140. An ozoneator 149 is connected to chamber 138 with the tube 141 that includes a short capillary device 147.

The subsystem 10 provides measurements of a gas sample indicative of the total concentration of non-basic nitrogen-containing gas-phase compounds in a gas sample as well as the total concentration of nitrogen-containing gas-phase compounds in the sample. The total concentration of basic nitrogen-containing gas-phase compounds in the gas sample can be determined from the difference between the total concentration of nitrogen-containing gas-phase compounds and the total concentration of non-basic nitrogen-containing gas-phase compounds in the gas sample. In preferred embodiments, predictions of remaining gas filter service life and evaluations of imminent or actual filter failure are based on a measured total concentration of basic nitrogen-containing gas-phase compounds in a gas sample.

Embodiments of the system may employ a converter 116 for converting gas-phase nitrogen-containing compounds, in a gas sample, to a detectable gas, herein referred to as “the indicator gas”, which is then detected. In preferred embodiments, the gas-phase nitrogen-containing compounds are converted to nitrogen monoxide (NO or nitric oxide), which serves as the indicator gas. In various embodiments, the conversion of gas-phase nitrogen-containing compounds to NO can be achieved by thermal oxidization using, for example, a heated stainless steel surface, a heated quartz surface, or a catalytic conversion surface. In a various embodiments, the conversion of gas-phase nitrogen-containing compounds to NO can be achieved by photo-catalytic conversion using, for example, an ultraviolet light source and a catalytic conversion surface.

Detector 138 can include a chemiluminescence detector employing an indicator gas. Preferably, in embodiments employing a NO indicator gas, the chemiluminescence detector has a reaction chamber connected to a source of ozone molecules (O₃) to produce electronically excited nitrogen dioxide molecules (NO₂), which are detected by the light emitted in their relaxation, and the emitted light detected is used to determine the concentration of NO. In various embodiments, a chemiluminescence NO detector is operated at reaction chamber target pressure in the range from about 70 Torr to about 120 Torr. A pressure reducer can be located upstream of the reaction chamber to facilitate achieving the target pressure. The pressure reducer can comprise, for example, a flow restrictor, and/or a calibrated glass capillary heated to reduce the amine-sticking coefficient.

In other embodiments, the detector may consist of a calorimetric detector, and in another embodiment, the detector is adapted to detect nitrogen oxides (NOₓ).

Scrubber 118 may consist of a strong cation exchange resin. In various embodiments, scrubber 118 can contain photoresist coated beads, the photoresist coating preferably corresponding to the photoresist of a photolithography process being monitored. In addition, scrubber 118 can be constructed to remove select basic gas-phase nitrogen containing species from a gas sample while not substantially removing other select basic gas-phase nitrogen containing species. For example, scrubber 118 can be constructed to remove basic gas-phase nitrogen containing species having a pKa value above a certain value, below a certain value, or within a range of pKa values. In various embodiments, the systems and methods of the present invention use two more scrubbers. The two or more scrubbers can include one or more scrubbers constructed to remove basic gas-phase nitrogen containing species from a gas sample and one or more scrubbers constructed to remove select basic gas-phase nitrogen containing species from a gas sample while not substantially removing other select basic gas-phase nitrogen containing species. In various embodiments employing two or more scrubbers, valving can be included to bypass one or more of the scrubbers and, for example, thereby select which scrubbers a gas sample is passed through. Channel 104 may consist of a pass through device in that contaminants present at the input of channel 104 are passed to the output a valve 132.

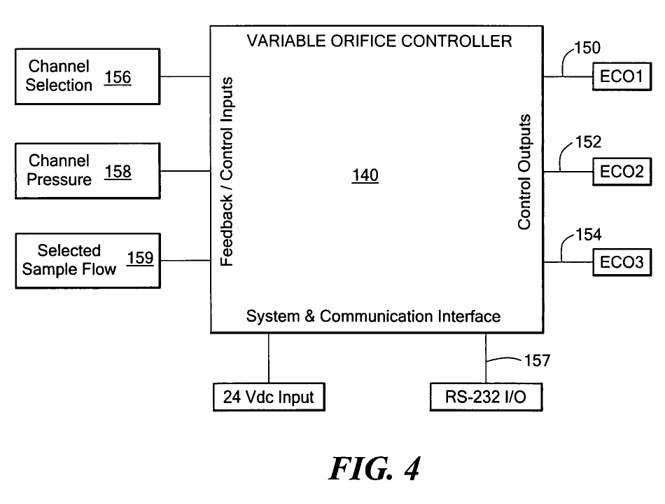

FIG. 4 illustrates a controller 140 that directly controls orifaces 110, 112, 114 at liners 150, 152, 154, has inputs for channel selection 156, chamberpressure 158 and selected sample flow rate 159. The controller is connected at port 151 system 240.

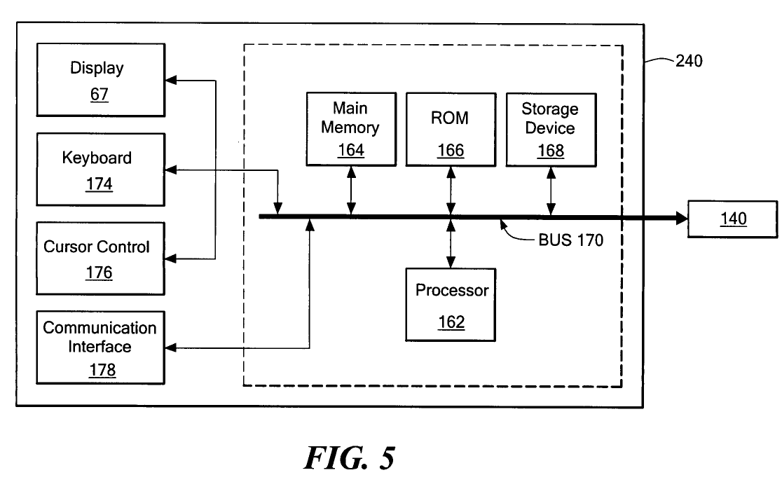

Embodiments of monitor including a controller 140 for controlling the flow of gas through the system, for operating detector 26, for gating gas samples to detector 26 using manifold 22, for operating display 67, for communicating over a network, and the like. FIG. 5 illustrates an embodiment of a control system 240 in the form of a general-purpose computer that executes machine-readable instructions, or function-executable code, for performing control of VSO system 65. The exemplary computer 240 includes a processor 162, main memory 164, read only memory (ROM) 166, storage device 168, bus 170, display 67, keyboard 174, cursor control 176, and communication interface 178.

The processor 162 may be any type of conventional processing device that interprets and executes instructions. Main memory 164 may be a random access memory (RAM) or a similar dynamic storage device. Main memory 164 stores information and instructions to be executed by processor 162. Main memory 164 may also be used for storing temporary variables or other intermediate information during execution of instructions by processor 162. ROM 166 stores static information and instructions for processor 162. It will be appreciated that ROM 166 may be replaced with some other type of static storage device. The data storage device 168 may include any type of magnetic or optical media and its corresponding interfaces and operational hardware. Data storage device 168 stores information and instructions for use by processor 162. Bus 170 includes a set of hardware lines (conductors, optical fibers, or the like) that allow for data transfer among the components of computer 240.

The display device 50 may be a cathode ray tube (CRT), liquid crystal display (LCD) or the like, for displaying information to a user. The keyboard 174 and cursor control 176 allow the user to interact with the computer 240. In alternative embodiments, the keyboard 174 may be replaced with a touch pad having function specific keys. The cursor control 176 may be, for example, a mouse. In an alternative configuration, the keyboard 174 and cursor control 176 can be replaced with a microphone and voice recognition means to enable the user to interact with the computer 240.

Communication interface 178 enables the computer 240 to communicate with other devices/systems via any communications medium. For example, communication interface 178 may be a modem, an Ethernet interface to a LAN (wired or wireless), or a printer interface. Alternatively, communication interface 178 can be any other interface that enables communication between the computer 240 and other devices or systems.

By way of example, a computer 240 consistent with the present invention provides system 65 with the ability to communicate over a network while operating in a semiconductor fabrication facility. Alternatively, the network may convey signals to system 65 for remotely turning the unit on at a determined time and for remotely turning the unit off when a measurement interval has been concluded. In addition, computer 240 may be used to calibrate components within system 65. The computer 240 performs operations necessary to complete desired actions in response to processor 162 executing sequences of instructions contained in, for example, memory 164. Such instructions may be read into memory 164 from another computer-readable medium, such as a data storage device 168, or from another device via communication interface 178. Execution of the sequences of instructions contained in memory 164 causes processor 162 to perform a method for controlling VSO system 65. Alternatively, hard-wired circuitry may be used in place of or in combination with software instructions to implement the present invention. Thus, the present invention is not limited to any specific combination of hardware circuitry and software.

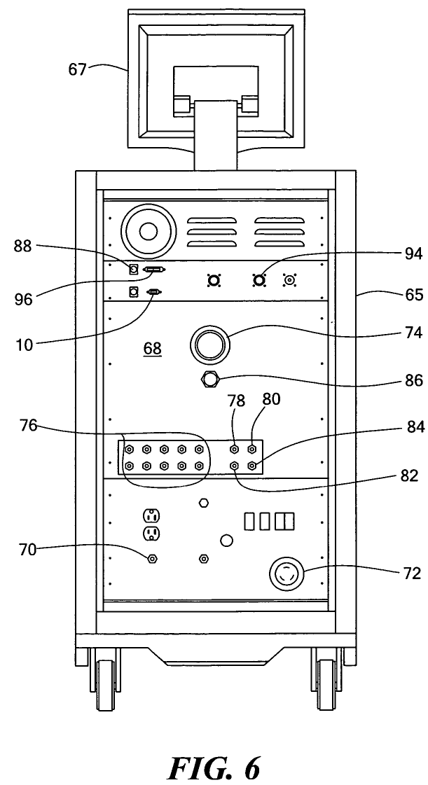

FIG. 6 illustrates an exemplary housing panel 68 for use with embodiments of system housing 65. Panel 68 may be fabricated from aluminum, plastic, composite, and the like. A display 67 rear panel 68 may include circuit breaker 70 for providing overload protection to electrically powered components within subsystem 10. A main power inlet 72 may be provided for coupling a power source to subsystem 10. Embodiments of subsystem 10 can be powered using 110-120V AC or 220-240V AC from a standard wall outlet. A pressure gauge 74 may be used for showing the setting of a regulator 86 used for maintaining a constant pressure within system 10. A plurality of gas sample inlets 76 are provided for coupling gas sample lines to system 10. Gas sample inlets 76 can be configured according to customer preferences. A clean dry air (CDA) inlet 78 can also be provided to further satisfy customer preferences.

A sample exhaust connector 80 is provided for coupling an exhaust line to system 10. If desired, exhaust connector 80 may have a scrubber mounted in line for removing contaminants. The scrubber can be mounted inside system 10, or it may be mounted between exhaust connector 80 and an exhaust line. An autocal exhaust 82 is provided for facilitating removal of gases and/or contaminants associated with calibrating subsystem 10. A pre-sample exhaust connector 84 may further be provided for exhausting sampled ambient air.

Subsystem 10 may also include a network connector 88 for coupling system 65 to a data communications network such as an Internet protocol (IP) network. System 65 may communicate over a network to receive software updates, to facilitate remote diagnostics, for communicating measurement data with remote locations, and the like. System 65 may further include a serial communication port 5 and a parallel communication port 92 for facilitating communication with devices such as keyboards, printers, and peripheral input devices such as a computer mouse or track ball. System 65 also includes an alarm output 94 for making an alarm signal available to an operator or user thereof. System 65 can further send alarm signals over a network using network connector 88 instead of, or in addition to, using alarm output 94.

The rear panel 68 illustrated in FIG. 6 is exemplary and the connector configuration shown can be modified, rearranged, removed, and additional connectors can be added without departing from the spirit of embodiments discussed herein.

In a preferred embodiment, monitor 65 weighs approximately 500 lbs. and has a height of approximately 47 inches, a width of approximately 25 inches and a depth of approximately 36 inches.

The systems and methods of the present invention can include a calibration system and methods for calibrating detector response to the indicator gas. In various embodiments, a reference gas sample is provided to calibrate a zero point of the detector as well as the absolute response of the detector to a known concentration of the indicator gas. The reference gas sample can be provided by a gas source having a concentration of indicator gas below the lower detection limit of the detector, such a source provides zero air.

A reference gas sample for calibration of the zero point (zero air) is provided by the output of a chemical filter system (output sample location) comprising a series of filter stages through which air passes. In one embodiment the indicator gas concentration at a location preceding the outlet of the filtering system (upstream sampling location) is measured relative to the concentration at the outlet to determine when air at the outlet is valid as a zero reference, preferably the stage preceding the outlet is located immediately preceding the last filter stage of the filter system. The fidelity of the zero air from the outlet can be evaluated by comparing the concentration of indicator gas in a gas sample from the output sample location with the concentration in a gas sample from the upstream sample location. In various embodiments, a source of zero air is provided by a generator comprising a filter for filtering the ambient air, and/or a liquid scrubber solution that filters the ambient air by bubbling the air through the solution.

A differential reading between the filter 20, 20′ outlet and an intermediate sampling point is also advantageously employed to indicate the time when the elements of the filter system should be replaced. A zero differential reading indicates all of the contaminants are still being removed by the filter stages upstream of the intermediate sampling port 18, 18′, while a positive value indicates that some contaminants have reached the intermediate point 18, 18′ and can only be removed in the final stage of the filter.

Another way of predicting the time for filter replacement employs using the total amine detector to detect total amines from a sample port upstream of the filtering system. This provides information regarding the past history of contaminant concentration in the airflow that has passed through the filtering system. The contamination of air entering the system may change because of the season of the year, industrial or agricultural activity in the region, or accidental spills within the facility. The overall contamination rate is monitored over time at the upstream sample port 16, 16′. And, by correlation of this history of contaminant loading with past performance of the filter, as monitored at an intermediate stage 18, 18′, the amount of filter life remaining is projected, and the time is set when the filter elements should be changed.

In a system combining these features, information from the outlet sample location 20, 20′ of the filtering system is employed to assure that no contaminant enters the environment to be protected, the intermediate port 18, 18′ is employed to provide for early warning, and the upstream sample 16, 16′ is employed to provide information about background contamination and is used to determine filter performance.

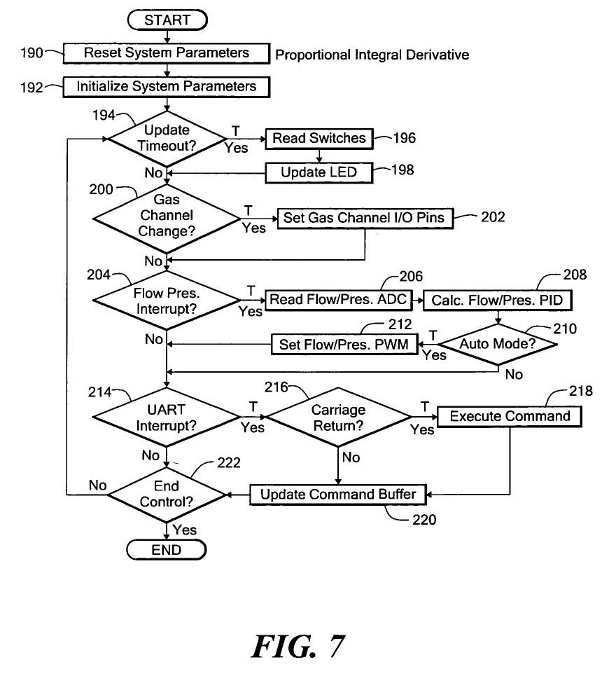

FIG. 7 illustrates an exemplary method for controlling VSO system 65 when making measurements. The method commences when subsystem parameters are reset (per step 190). Then system parameters are initialized (per step 192). Examples of system parameters that can be initialized are, but are not limited to, input/output, ADC's, timers, PID instructions, and command buffers. After parameters are initialized, a check is made for update timeouts (per step 194). If an update timeout has occurred, system switches are read (per step 196) and light emitting diodes (LEDs) are activated in a manner causing them to provide an update to a user thereof (per step 198) before the method flow returns to the input of step 200. In contrast, if no update timeout has occurred, flow continues directly to step 200.

A determination is made as to whether a gas sample channel has changed (per step 200). If the gas sample channel has changed, gas sample channel I/O pins are set (per step 202) and then flow returns to the input of step 204. In contrast, if no sample gas channel change is detected, flow continues directly to step 204.

A check is made for flow and/or pressure interrupts (per step 204). If a flow/pressure interrupt has occurred, the ADC's associated with flow meters and pressure meters are read (per step 206). Then, flow and pressure PID inputs are calculated using controller 140 (per step 208). If system 100 is operating in auto mode after step 208 (per step 210), PWM parameters are set for the flow and pressure meters (per step 212). If the system 100 is not operating in auto mode, method flow returns to the input of step 214. In contrast, if no flow/pressure interrupt was present in step 204, the method flow goes directly to the input of step 214.

A check is made for the existence of a universal asynchronous receiver transmitter (UART) interrupt (per step 214). If a UART interrupt is present, a check is made for the existence of a carriage return (per step 216). If a carriage return is present, a specified command is executed (per step 218). In contrast, if no carriage return was present, method flow goes to the input of step 220 when a command buffer is updated (per step 220). Step 220 is also executed if a command has been executed by way of the presence of a carriage return. If no UART interrupt is present, method flow returns to the input of step 194 (per step 222) and checks for an update timeout. Method flow also returns to the input of step 194 after updating a command buffer in step 220.

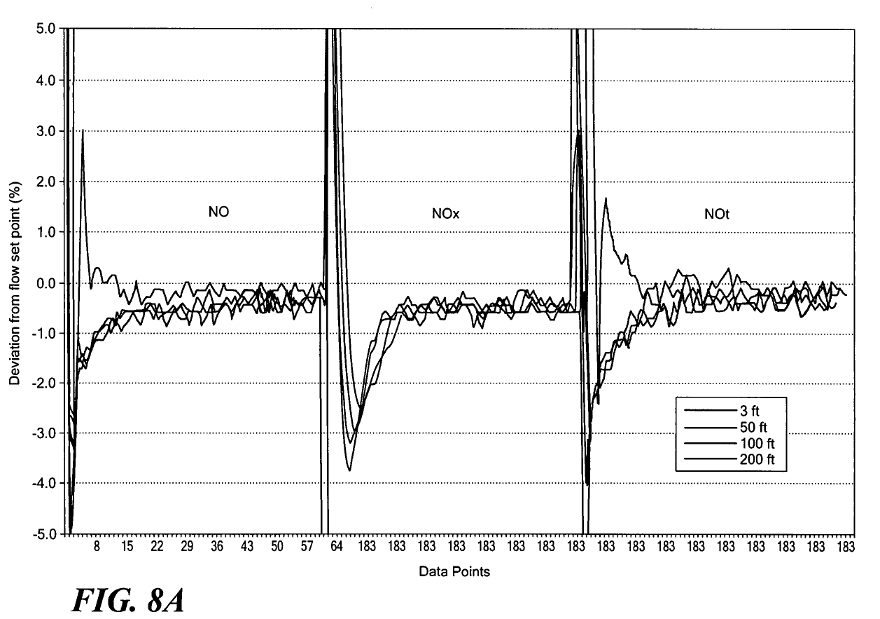

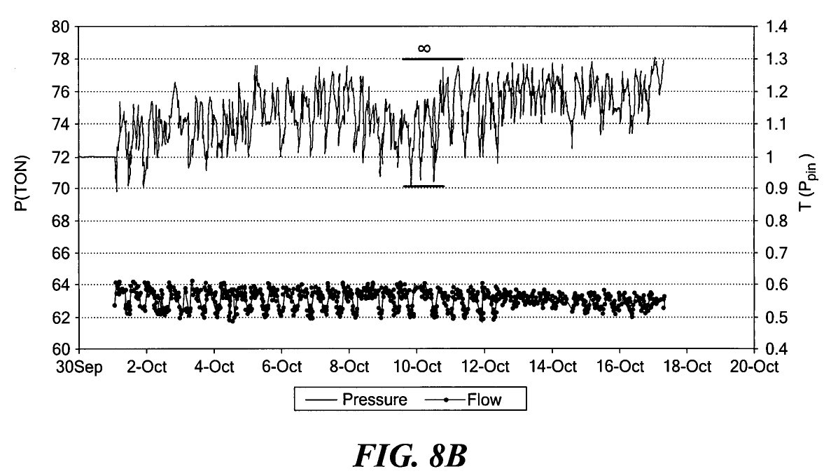

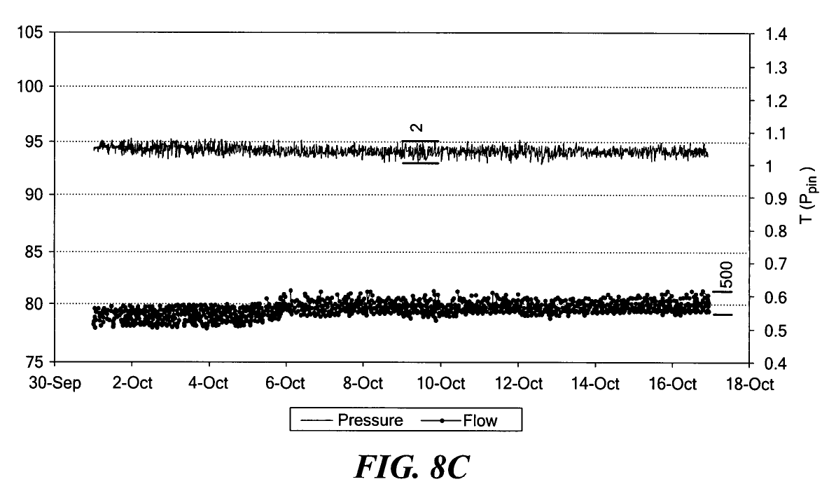

FIG. 8A shows the transition to stable flow for each delivery channel. This shows that the flow in a three channel system stabilizes after 3 to 5 seconds then reads the flow which is stable to within 0.5% regardless of whether the input flow lines are 3 feet to 200 feet in operation. FIG. 8B illustrates the performance of flow and pressure deviation for prior art systems. FIG. 8C illustrates the improvement in flow and pressure active control in accordance with the invention.

The claims should not be read as limited to the described order or elements unless stated to that effect. Therefore, all embodiments that come within the scope and spirit of the following claims and equivalents thereto are claimed as the invention.

What is claimed:

1. A gas monitor for detecting contaminants in a gas:
an inlet gas channel for providing a gas sample;
a first delivery channel connected to the inlet gas channel, the first delivery channel having a first variable orifice positioned to regulate gas flow therethrough;
a second delivery channel connected to the inlet gas channel, the second delivery channel having a second variable orifice positioned to regulate gas flow therethrough;
a detector that selectably receives a gas sample from the first channel or the second channel; and
an orifice controller that controls the size of the first variable orifice and the second variable orifice, the controller regulating gas pressure at the detector.

2. The gas monitor of claim 1 further comprising a vacuum source in fluid communication with the gas monitor.

3. The gas monitor of claim 1 further comprising a bypass channel that conducts gas flow from unselected delivery channels, the bypass channel having a gas pressure regulated by the controller.

4. The gas monitor of claim 1 further comprising:
a converter connected to the first delivery channel; and
a second converter connected to the second delivery channel.

5. The gas monitor of claim 1 further comprising:
a third delivery channel connected to a third variable orifice.

6. The gas monitor of claim 5 further comprising:
a first valve for selectively making the gas sample available to the detector after passing through the first delivery channel;
a second valve for selectively making the gas sample available to the detector after passing through the second delivery channel; and
a third valve for selectively making the gas sample available to the detector after passing through the third delivery channel.

7. The gas monitor of claim 6 wherein the first valve, second valve or third valve is selectively operated to make the gas sample available to the detector.

8. The gas monitor of claim 1 wherein the detector further includes a reaction chamber.

9. The gas monitor of claim 5 wherein the detector receives the gas sample at a determined flow rate from the first delivery channel, the second delivery channel or third delivery channel.

10. The monitor of claim 7 further comprising a flow meter that monitors a gas flow to the detector.

11. The monitor of claim 1 further comprising a pressure sensor that monitors a gas pressure at the detector.

12. The monitor of claim 1 further comprising a temperature controller that controls a converter temperature.

13. The gas monitor of claim 1 wherein the orifice controller regulates gas flow such that the gas flow rate has a variance of approximately 0.5% from a target flow rate for the delivery channel selectably providing the gas sample to the detector.

14. The gas monitor of claim 13 wherein the target flow rate is in the range from approximately 400 cc/min to about 700 cc/min and the target pressure is in the range from approximately 70 Torr to 120 Torr.

15. The gas monitor of claim 8 wherein the orifice controller regulates gas flow such that the pressure in the reaction chamber has a variance of approximately 0.5% from a target pressure.

16. The gas monitor of claim 1 wherein the variable orifices are voltage sensitive orifices.

17. The gas monitor of claim 1 wherein the second delivery channel comprises a scrubber.

18. The gas monitor of claim 1 wherein one or more of the first delivery channel and the second delivery channel comprises a converter that converts nitrogen containing compounds to nitrogen oxide (NO).

19. The gas monitor of claim 18 wherein the converter comprises a thermal catalytic converter having a catalytic element and a heating element.

20. The gas monitor of claim 18 wherein the converter comprises a photolytic converter having an ultraviolet light source.

21. The gas monitor of claim 8 wherein the orifice controller regulates gas flow by adjusting the size of one of the first, second or third variable orifices and further regulates the gas pressure in the reaction chamber by adjusting the size of the other variable orifices.

22. The gas monitor of claim 8 wherein the orifice controller regulates gas flow by adjusting the size of the first, second and third variable orifices such that the gas flow rate through the delivery channel selectably provide the gas sample to the reaction chamber.

23. The gas monitor of claim 8 wherein the reaction chamber is connected to an ozone generator, the reaction chamber configured to react nitrogen monoxide (NO) molecules with ozone molecules (O₃) to produce electronically excited nitrogen dioxide molecules (NO₂*).

24. A method of monitoring contaminants in a gas used in a semiconductor manufacturing system, the method comprising the steps of:
receiving a gas sample from one of a plurality of delivery channels producing a received gas sample, each of the plurality of delivery channels having a variable orifice for adaptively regulating the passage of the gas sample therethrough, the plurality of variable orifices cooperatively operated by a controller for maintaining a determined flow rate and pressure of the gas sample; and
monitoring at least one of a contaminant in the received gas sample.

25. The method of claim 24 further comprising providing a converter associated with at least two delivery channels.

26. The method of claim 24 further comprising receiving the gas sample at a detector.

27. The method of claim 26 further comprising providing a chemiluminescence detector.

28. The method of claim 27 wherein the detector further comprises a reaction chamber.

29. The method of claim 24 wherein the variable orifices comprise voltage sensitive orifices.

30. The method of claim 24 further comprising:
a pressure sensor communicatively coupled to the controller; and
a flow sensor communicatively coupled to the controller.

31. A method of monitoring one or more nitrogen-compounds in a sampled gas, comprising the steps of:
passing a first gas sample to a detector through a first flow path having a first variable orifice such that the flow rate has a variance of approximately 0.5% from a target flow rate, the first flow path comprising a converter which converts gaseous nitrogen compounds into a first indicator gas;
detecting the concentration of the first indicator gas sample with the detector;
passing a second gas sample to the detector through a second flow path having a second variable orifice such that the flow rate has a variance of approximately 0.5% from a target flow rate, the second flow path comprising a scrubber and a converter, the scrubber for removing basic nitrogen compounds from the second gas sample and the converter for converting gaseous nitrogen compounds into a second indicator gas;
detecting the concentration of the second indicator gas sample from the second gas sample with the detector; and
determining a basic-nitrogen-compound concentration by comparing the detected concentration of the first indicator gas to the detected concentration of the second indicator gas.

32. The method of claim 31 further comprising providing a target flow rate is in the range from approximately 0.Ll min to 2 Lpm;

33. The method of claim 31 wherein the step of detecting the concentration of the first indicator gas comprises controlling the pressure in the detector during detection of the first indicator gas such that the pressure in the detector has a variance of approximately 0.5% from a target pressure, and wherein the step of detecting the concentration of the second indicator gas comprises controlling the pressure in the detector during detection of the second indicator gas such that the pressure in the detector has a variance of approximately 0.5% from a target pressure.

34. The method of claim 33 further comprising providing a target pressure is in the range of approximately 20 Torr to 750 Torr.

35. The method of claim 31 wherein the size of the first variable orifice is controlled such that the gas flow rate through the first channel when determining the concentration of the first indicator gas and pressure the size of the second variable orifice is controlled so that the gas pressure in the reaction chamber is controlled.

36. The method of claim 31, further comprising the step of purging the scrubber while maintaining substantially uninterrupted flow of gas samples to the detector.

37. The method of claim 31, further comprising obtaining the gas samples from a photolithography tool cluster.

38. The method of claim 31 further comprising the steps of:
passing a third gas sample to the detector through a third flow path having a third variable orifice such that the flow rate has a variance of approximately 0.5% from a target flow rate;
detecting the concentration of a third indicator gas with the detector; and
determining a non-basic-nitrogen-compound concentration by comparing the detected concentration of the third indicator gas to the detected concentration of the second indicator gas.

39. The method of claim 38 wherein the target flow rate is in the range of approximately 0.1 cc/min to 2.0 cc/min.

40. The method of claim 38 wherein,
the step of detecting the concentration of the first indicator gas comprises controlling the pressure in the detector during detection of the first indicator gas such that the pressure in the detector has a variance of approximately 0.5% from a target pressure;
the step of detecting the concentration of the second indicator gas comprises controlling the pressure in the detector during detection of the second indicator gas such that the pressure in the detector has a variance of approximately 0.5% from the target pressure; and
the step of detecting the concentration of the third indicator gas comprises controlling the pressure in the detector during detection of the third indicator gas such that the pressure in the detector has a variance of approximately 0.5% from a target pressure.

41. The method of claim 38, further comprising the step of purging the scrubber while maintaining substantially uninterrupted flow of the gas samples to the detector.

42. The method of claim 38, wherein the gas samples are taken from a photolithography tool cluster.

43. The method of claim 31, wherein the detector comprises a chemiluminescence detector.

44. The method of claim 29 further comprising operating a bypass channel to control pressure in the reaction chamber.

45. The method of claim 31 further comprising inserting an oxidant at an inlet channel delivering a gas sample to a variable orifice to nitrogen to nitrogen oxide.
